(19) United States
(12) Patent Application Publication
(10) Pub. No.: US 2010/0276214 A1
(43) Pub. Date: Nov. 4, 2010

(54) Tablet of battery-free wireless pointing device

(75) Inventors: Chih-Min Liu, Taipei (TW); Chih-Ming Liu, Taipei (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., Taipei (TW)

(21) Appl. No.: 12/457,997

(22) Filed: Jun. 29, 2009

(30) Foreign Application Priority Data
Apr. 29, 2009 (TW) 098114274

(51) Int. Cl. G06F 3/041

(52) U.S. Cl. 178/18.03; 178/19.01

(57) ABSTRACT

A tablet of a battery-free wireless pointing device has a battery-free wireless pointing device and a tablet. The wireless pointing device includes a power supply circuit and a sensing circuit. The tablet includes a signal processing unit, a first antenna loop, and a second antenna loop. The sensing circuit receives electric energy generated by the power supply and generates a sensing signal. The second antenna loop receives the sensing signal. The signal processing circuit generates a frequency signal and determines a current coordinate position of the pointing device according to the sensing signal.

### CROSS-REFERENCE TO RELATED APPLICATIONS

This non-provisional application claims priority under 35 U.S.C. §119(a) on Patent Application No(s). 098114274 filed in Taiwan, R.O.C. on Apr. 29, 2009 the entire contents of which are hereby incorporated by reference.

### BACKGROUND OF THE INVENTION

1. Field of the Invention

The present invention relates to an input apparatus, and more particularly to a tablet of a battery-free wireless pointing device powered by electromagnetic resonance.

2. Related Art

Tablets available in the current market are used together with wireless pointing devices, and when the wireless pointing device contacts with the tablet, the wireless pointing device generates an electromagnetic field, such that the tablet calculates a current coordinate position of the wireless pointing device through electromagnetic coupling, and then transmits the coordinate position to a computer end.

Currently, a power required by the operation of the wireless pointing device is mainly obtained in two manners. In the first manner, the power supply is obtained by using disposable batteries, and in the second manner, the power supply is obtained through electromagnetic resonance. If the power supply is obtained by using the disposable batteries, the wireless pointing device needs to replace the batteries frequently, such that it is extremely inconvenient for the user and it is quite not environment-friendly. Therefore, the electromagnetic resonance manner is currently the most suitable power supply manner.

However, in the current technique related to the power supply through the electromagnetic resonance of the wireless pointing device and the tablet, the tablet must emit a large magnetic field, and the wireless pointing device receives the magnetic field. After accumulating a certain amount of energy, the wireless pointing device emits the magnetic field to the tablet. This manner has the problems such as high power consumption of the tablet, complicated circuit design, high cost, and high radiation of the electromagnetic field.

Therefore, it is currently a problem to be solved in the industry how to lower the power consumption of the tablet, simplify the circuit design, reduce the cost price, and eliminate the problem of the excessively high radiation of the electromagnetic field.

### SUMMARY OF THE INVENTION

In view of the above problems, the present invention is a tablet of a battery-free wireless pointing device, which is capable of solving problems in the prior art resulting from power supply through electromagnetic resonance.

In order to achieve the above objective, the present invention provides a tablet of a battery-free wireless pointing device, which has a battery-free wireless pointing device and a tablet, and the two devices are used together.

The battery-free wireless pointing device at least comprises a power supply circuit and a sensing circuit.

The power supply circuit is used to wirelessly receive a frequency signal emitted from the tablet by using a plurality of sensing coils, and forms a mutual electromagnetic resonance through the frequency signal to generate a required electric energy.

The sensing circuit is used to receive the electric energy generated by the power supply circuit, generates a sensing signal, and emits the sensing signal.

Here, the battery-free wireless pointing device may be a wireless cursor pen or a wireless mouse.

### BRIEF DESCRIPTION OF THE DRAWINGS

The present invention will become more fully understood from the detailed description given herein below for illustration only, and thus are not limitative of the present invention, and wherein:

FIG. 1 is a schematic outside view of a tablet of a battery-free wireless pointing device according to an embodiment of the present invention;

FIG. 2 is a schematic view of a circuit structure of the tablet of the battery-free wireless pointing device according to an embodiment of the present invention; and

FIG. 3 is a schematic view of the circuit structure of the tablet of the battery-free wireless pointing device according to another embodiment of the present invention.

### DETAILED DESCRIPTION OF THE INVENTION

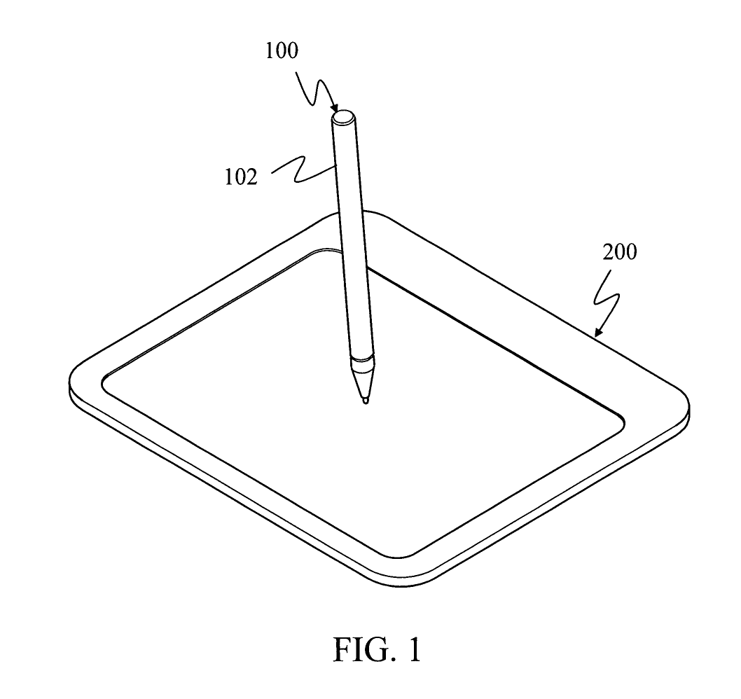

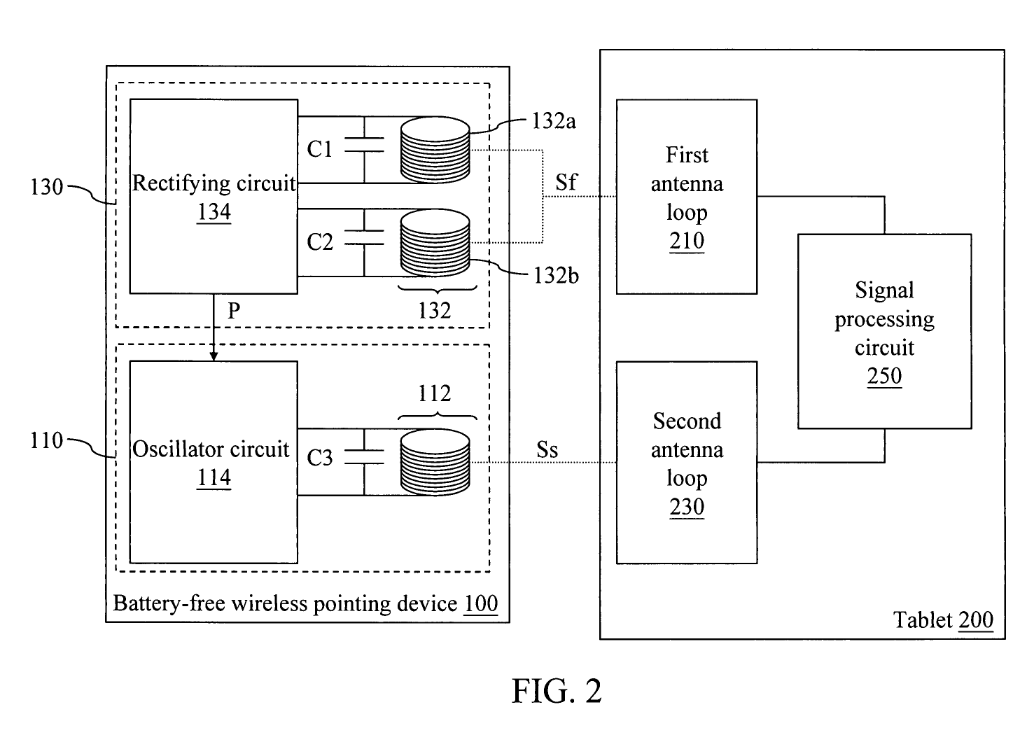

Referring to FIGS. 1 and 2, a tablet of a battery-free wireless pointing device comprises a battery-free wireless pointing device 100 and a tablet 200.

The battery-free wireless pointing device 100 at least comprises a power supply circuit 130 and a sensing circuit 110.

The power supply circuit 130 wirelessly receives a frequency signal Sf emitted from the tablet 200 by using a plurality of sensing coils 132, and forms a mutual electromagnetic resonance through the frequency signal Sf to generate a required electric energy P.

The sensing circuit 110 receives the electric energy P generated by the power supply circuit 130, generates a sensing signal Ss, and emits the sensing signal Ss to the tablet 200.

The power supply circuit 130 comprises a plurality of sensing coils 132 and a rectifying circuit 134.

The plurality of sensing coils 132 receives the frequency signal Sf emitted from the tablet 200, and forms the mutual electromagnetic resonance through the frequency signal Sf to generate an energy signal.

The rectifying circuit 134 is connected to the sensing coils 131, receives the energy signal emitted from the sensing coils 132, and generates the electric energy P by using the energy signal.

The relevant structure and the implementation of the sensing coils are further described by setting two sensing coils 132, namely, a first sensing coil 132a and a second sensing coil 132b, as an example. The first sensing coil 132a is adjacent to the second sensing coil 132b, and both the first sensing coil 132a and the second sensing coil 132b are connected to the rectifying circuit 134. A first capacitor C1 is coupled between two ends of the first sensing coil 132a. Similarly, a second capacitor C2 is coupled between two ends of the second sensing coil 132b.

When the first sensing coil 132a and the second sensing coil 132b receive the frequency signal Sf at the same time, the first sensing coil 132a and the second sensing coil 132b have the same frequency, so as to result in the electromagnetic resonance effect to generate an energy signal to the rectifying circuit 134.

The sensing circuit 110 comprises an oscillator circuit 114 and a sensing coil 112.

The oscillator circuit 114 receives the electric energy P generated by the power supply circuit 130, and generates a sensing signal Ss.

The sensing coil 112 is connected with the oscillator circuit 114, and emits the sensing signal Ss generated by the oscillator circuit 114 to the tablet 200.

The tablet 200 at least comprises a signal processing circuit 250, a first antenna loop 210, and a second antenna loop 230.

The signal processing circuit 250 generates a frequency signal Sf, and determines a current coordinate position of the battery-free wireless pointing device 100 according to the sensing signal Ss emitted from the battery-free wireless pointing device 100.

The first antenna loop 210 emits the frequency signal Sf.

The second antenna loop 230 wirelessly receives the sensing signal Ss.

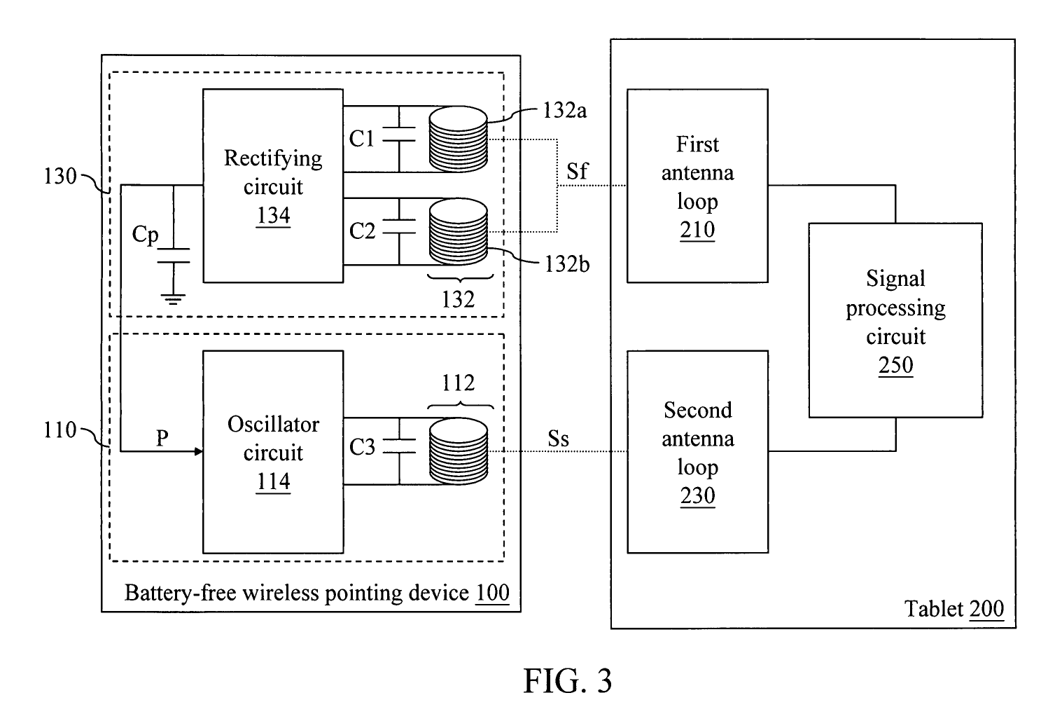

Referring to FIG. 3, an energy storage capacitor Cp may be disposed between the rectifying circuit 134 and the sensing circuit 110, in which the energy storage capacitor Cp stores the electric energy P output from the rectifying circuit 134, so as to supply the electric energy P to the sensing circuit 110.

What is claimed is:

1. A tablet of a battery-free wireless pointing device, comprising a battery-free wireless pointing device and a tablet, wherein the battery-free wireless pointing device at least comprises:
a power supply circuit, having a plurality of sensing coils, used to wirelessly receive a frequency signal emitted from the tablet by using the plurality of sensing coils, and form an electromagnetic resonance through the frequency signal to generate an electric energy; and
a sensing circuit, used to receive the electric energy generated by the power supply circuit, and generate a sensing signal to emit to the tablet,
wherein the tablet at least comprises:
a signal processing circuit, used to generate a frequency signal, and determine a current coordinate position of the battery-free wireless pointing device according to the sensing signal emitted from the battery-free wireless pointing device;
a first antenna loop, used to emit the frequency signal; and
a second antenna loop, used to wirelessly receive the sensing signal.

2. The tablet of a battery-free wireless pointing device according to claim 1, wherein the plurality of sensing coils is used to form the mutual electromagnetic resonance through the frequency signal to generate an energy signal, and the power supply circuit further comprises:
a rectifying circuit, connected to the plurality of sensing coils, used to receive the energy signal emitted from the plurality of sensing coils, and generate the electric energy by using the energy signal.

3. The tablet of a battery-free wireless pointing device according to claim 2, wherein the power supply circuit further comprises an energy storage capacitor, connected between the rectifying circuit and the sensing circuit, and used to store the electric energy.

4. The tablet of a battery-free wireless pointing device according to claim 1, wherein the sensing circuit comprises:
an oscillator circuit, used to receive the electric energy generated by the power supply circuit, and generate the sensing signal; and
a sensing coil, connected with the oscillator circuit, and used to emit the sensing signal generated by the oscillator circuit to the tablet.

5. The tablet of a battery-free wireless pointing device according to claim 1, wherein the battery-free wireless pointing device is a wireless cursor pen or a wireless mouse.

6. A battery-free wireless pointing device, at least comprising:
a power supply circuit, having a plurality of sensing coils, used to wirelessly receive a frequency signal by using the plurality of sensing coils, and form an electromagnetic resonance through the received frequency signal to generate an electric energy; and
a sensing circuit, used to receive the electric energy generated by the power supply circuit, and generate a sensing signal.

7. The battery-free wireless pointing device according to claim 6, wherein the plurality of sensing coils is used to form the mutual electromagnetic resonance through the frequency signal to generate an energy signal, and the power supply circuit further comprises:
a rectifying circuit, connected to the plurality of sensing coils, used to receive the energy signal emitted from the plurality of sensing coils, and generate the electric energy by using the energy signal.

8. The battery-free wireless pointing device according to claim 7, wherein the power supply circuit further comprises an energy storage capacitor, connected between the rectifying circuit and the sensing circuit, and used to store the electric energy.

9. The battery-free wireless pointing device according to claim 6, wherein the sensing circuit comprises:
an oscillator circuit, used to receive the electric energy generated by the power supply circuit, and generate the sensing signal; and
a sensing coil, connected with the oscillator circuit, and used to emit the sensing signal generated by the oscillator circuit.

10. The battery-free wireless pointing device according to claim 6, wherein the battery-free wireless pointing device is a wireless cursor pen or a wireless mouse.
